(19) United States
(12) Patent Application Publication
(10) Pub. No.: US 2017/0179449 A1
(43) Pub. Date: Jun. 22, 2017

(54) MEDICAL BATTERY

(71) Applicant: OLYMPUS CORPORATION, Tokyo (JP)

(72) Inventor: Shoei TSURUTA, Tokyo (JP)

(73) Assignee: OLYMPUS CORPORATION, Tokyo (JP)

(21) Appl. No.: 15/451,512

(22) Filed: Mar. 7, 2017

Related U.S. Application Data
(63) Continuation of application No. PCT/JP2014/080233, filed on Nov. 14, 2014.

(51) Int. Cl. H01M 2/10; H01M 10/42; H01M 10/658

(52) U.S. Cl. CPC H01M 2/1094; H01M 10/658; H01M 10/425

(57) ABSTRACT

A medical battery includes: a chargeable and dischargeable battery cell; a first electrode and a second electrode that are connected to the battery cell and are electrically connected to external electrodes in a non-contact state; a switching unit that is provided in a battery circuit including the battery cell, the first electrode, and the second electrode, the switching unit being configured to switch a current flowing through the battery circuit to an alternating current or a direct current; an insulating housing that seals and houses the battery cell, the first electrode, the second electrode, and the switching unit therein; and a heat storage unit arranged between an inner surface of the housing and the first electrode, and between the housing and the second electrode.

### BACKGROUND OF THE INVENTION

Field of the Invention

The present invention relates to a medical battery that can be used, for example, to supply power to a medical instrument.

This application is a continuation application based on a PCT International Application No. PCT/JP2014/080233, filed on Nov. 14, 2014, and the content of the PCT International Application is incorporated herein by reference.

Description of Related Art

Recently, making a medical instrument wireless has been under way, and a type of treatment tool for supplying power using a battery has started to be proposed.

At this time, it is generally expected that a lithium-ion battery in which energy density per unit mass is high will be applied. When the lithium-ion battery is exposed to high temperatures, there is a possibility of battery performance being degraded. For this reason, sterilization treatment such as ethylene oxide gas (EOG) sterilization having no need for high-temperature conditions is carried out.

For medical applications, high-pressure steam sterilization such as autoclaving is preferably carried out even on the battery. However, since autoclave sterilization is sometimes carried out under steam conditions of 135° C. and about 2.2 atm. for about 20 minutes, if a medical instrument in which a battery for which countermeasures against these environments are not carried out is mounted undergoes the autoclave sterilization, battery performance of the mounted battery may be degraded. Therefore, supply of a medical battery having excellent heat resistance is desired.

As a configuration for enhancing heat resistance of the battery, the configuration described in Japanese Patent (Granted) Publication No. 4554222 is proposed. In Japanese Patent (Granted) Publication No. 4554222, a battery means is surrounded by a thermal conduction reducing means and is used as a battery unit, and an electrode member electrically connected to positive and negative electrodes of the battery means is disposed on an outer surface of the battery unit.

### SUMMARY OF THE INVENTION

According to a first aspect of the present invention, a medical battery includes: a chargeable and dischargeable battery cell; a first electrode and a second electrode connected to the battery cell and electrically connected to external electrodes in a non-contact state; a switching unit provided in a battery circuit including the battery cell, the first electrode, and the second electrode, the switching unit being configured to switch a current flowing through the battery circuit to an alternating current or a direct current; a dielectric housing configured to seal and house the battery cell, the first electrode, the second electrode, and the switching unit therein; and a heat storage unit arranged between an inner surface of the housing and the first electrode, and between the housing and the second electrode.

According to a second aspect of the present invention, in the medical battery according to the first aspect, the heat storage unit may be arranged to cover the entire inner surface of the housing.

According to a third aspect of the present invention, in the medical battery according to the first aspect or the second aspect, the heat storage unit may be in contact with the first electrode, the second electrode, and the switching unit.

According to a fourth aspect of the present invention, in the medical battery according to any one of the first aspect to the third aspect, the heat storage unit may be formed by including a heat insulating material.

According to a fifth aspect of the present invention, in the medical battery according to any one of the first aspect to the fourth aspect, each of the first electrode and the second electrode may be formed in a planar shape, and be electrically connected to the external electrodes by capacitive coupling.

According to a sixth aspect of the present invention, in the medical battery according to any one of the first aspect to the fifth aspect, the housing may be formed of a material, a dielectric constant of which is equal to or more than 2.

According to a seventh aspect of the present invention, the medical battery according to any one of the first aspect to the sixth aspect may further include a heat insulator arranged around the battery cell.

According to an eighth aspect of the present invention, in the medical battery according to any one of the first aspect to the seventh aspect, the switching unit may be configured to switch between a charging mode and a discharging mode.

According to a ninth aspect of the present invention, in the medical battery according to any one of the first aspect to the eighth aspect, wiring connected between the first electrode and the battery cell, and between the second electrode and the battery cell may be equal to or more than a predetermined length.

### BRIEF DESCRIPTION OF DRAWINGS

FIG. 1 is a perspective view showing a medical battery according to a first embodiment of the present invention.

FIG. 2 is a sectional view of the medical battery.

FIG. 3 is a perspective view showing the medical battery and a charger.

FIG. 4 is a schematic partial sectional view of the charger.

FIG. 5 is a circuit diagram at the time of charging.

FIG. 6 is a perspective view showing a treatment tool in which the medical battery is mounted.

FIG. 7 is a circuit diagram at the time of discharging to the treatment tool.

FIG. 8 is a sectional view in a modification of the medical battery.

FIG. 9 is a sectional view in another modification of the medical battery.

FIG. 10 is a sectional view showing a medical battery of a second embodiment of the present invention.

FIG. 11 is a sectional view showing a medical battery of a third embodiment of the present invention.

FIG. 12 is a sectional view showing a medical battery of a fourth embodiment of the present invention.

FIG. 13 is a perspective view showing another modification of the medical battery of the present invention.

FIG. 14 is a perspective view showing another modification of the medical battery.

### DETAILED DESCRIPTION OF THE INVENTION

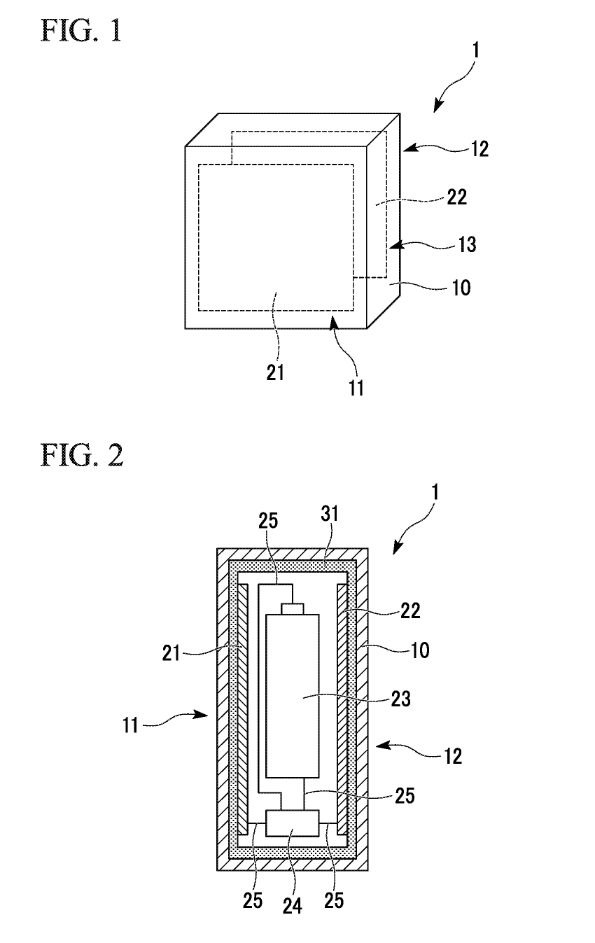

A first embodiment of the present invention will be described with reference to FIGS. 1 to 9.

FIG. 1 is a perspective view showing a medical battery 1 (hereinafter referred to simply as “battery”) of the present embodiment. The battery 1 is provided with a dielectric housing 10 forming an outer surface thereof, and first and second electrodes 21 and 22 disposed in the housing 10.

The housing 10 is formed of a hollow dielectric material. As the material of which the housing 10 is formed, a resin material is suitable. Since the battery 1 is used for medical purposes, a material that can sufficiently withstand a high-temperature, high-pressure environment arising during autoclaving, for example, fluorine resin, fluororubber, polyether ether ketone (PEEK), or the like, can be used as the material of the battery 1. The dielectric constant of the dielectric material of which the housing 10 is formed is preferably equal to or higher than 2. If the housing 10 is formed of a high-k material whose dielectric constant is equal to or higher than 2, capacitance generated during power reception and transmission (to be described below) can be increased, and thus a voltage value applied to electrodes during power reception and transmission can be reduced.

The housing 10 naturally maintains complete sealability (air-tightness) suitable for withstanding the aforementioned autoclaving.

FIG. 2 is a sectional view of the battery 1, and shows a state viewed from a right side 13 shown in FIG. 1. A chargeable and dischargeable battery cell 23 and a switching unit 24 electrically connected to the first and second electrodes 21 and 22 are sealed and housed inside the housing 10. The first electrode 21, the second electrode 22, the battery cell 23, and the switching unit 24 are connected by wiring 25, and form a battery circuit.

The switching unit 24 has two functions. One of the two functions is to switch alternating current/direct current of a current flowing in this battery circuit, and the other is to switch between discharging the alternating current to the outside of the battery and charging a battery cell with the direct current. Thereby, on the basis of the switching unit 24, the direct current flows to the battery cell 23 side, and the alternating current flows to the first electrode 21 side and the second electrode 22 side, so that a discharge mode and a charge mode are switched.

Although the battery does not have the function of switching between the charge and discharge modes, the battery can be used, for example, as a disposable battery in which only discharging is allowed.

As the battery cell 23, any battery cell will do as long as it is chargeable and dischargeable and, for example, various battery cells having known structures, such as a lithium-ion battery cell, may be appropriately selected and used.

Each of the first electrode 21 and the second electrode 22 is formed of a conductor in a planar shape. The material of which the first electrode 21 and the second electrode 22 are formed may include, for example, a metal foil.

The switching unit 24 is not particularly limited as long as it has a DC/AC conversion function, and a known converter circuit or the like may be appropriately selected in consideration of the size of the battery 1 or the like.

A heat storage unit 31 having a heat storage function is provided on an inner surface of the housing 10. In the present embodiment, the heat storage unit 31 is disposed to completely cover the inner surface of the housing 10. The planar first and second electrodes 21 and 22 are disposed on regions of the heat storage unit 31 which cover front and rear surfaces 11 and 12 of the housing 10. The heat storage unit 31 is interposed between the housing 10 and the first electrode 21 and between the housing 10 and the second electrode 22.

A material of which the heat storage unit 31 is formed is not particularly limited as long as it meets the following conditions. That is, in comparison with a state in which the first electrode 21 and the second electrode 22 are directly mounted on the inner surface of the housing 10, it will suffice if an amount of heat transferred to the first electrode 21 and the second electrode 22 from heat applied to the housing 10 from the outside of the battery 1 can be reduced. For example, various known sensible heat storage materials, latent heat storage materials, and chemical heat storage materials may be appropriately selected and used.

With the configuration as described above, the battery 1 is configured such that the dielectric housing 10 covers the entire outer surface thereof and the conductive members such as terminals or electrodes are never exposed to the outer surface thereof.

Next, an operation of the battery 1 when in use will be described.

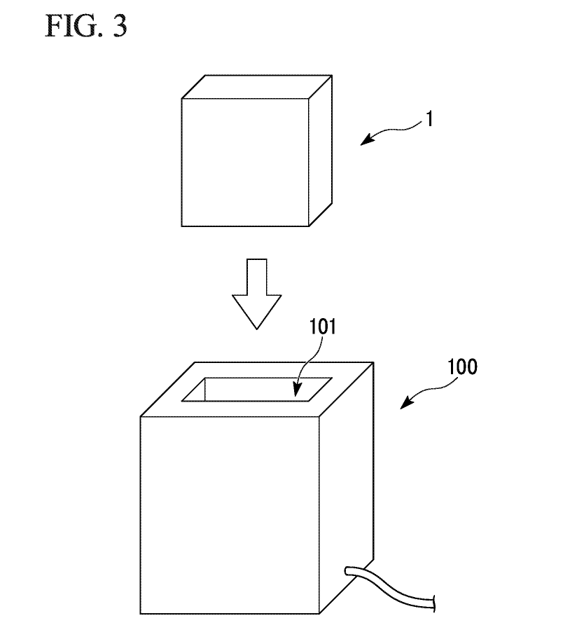

A charger 100 for charging the battery 1 is shown in FIG. 3. The charger 100 has a recess 101 in which the battery 1 can be housed, and is formed such that an entire outer surface of the charger 100 including the recess 101 is covered with a dielectric material such as a resin.

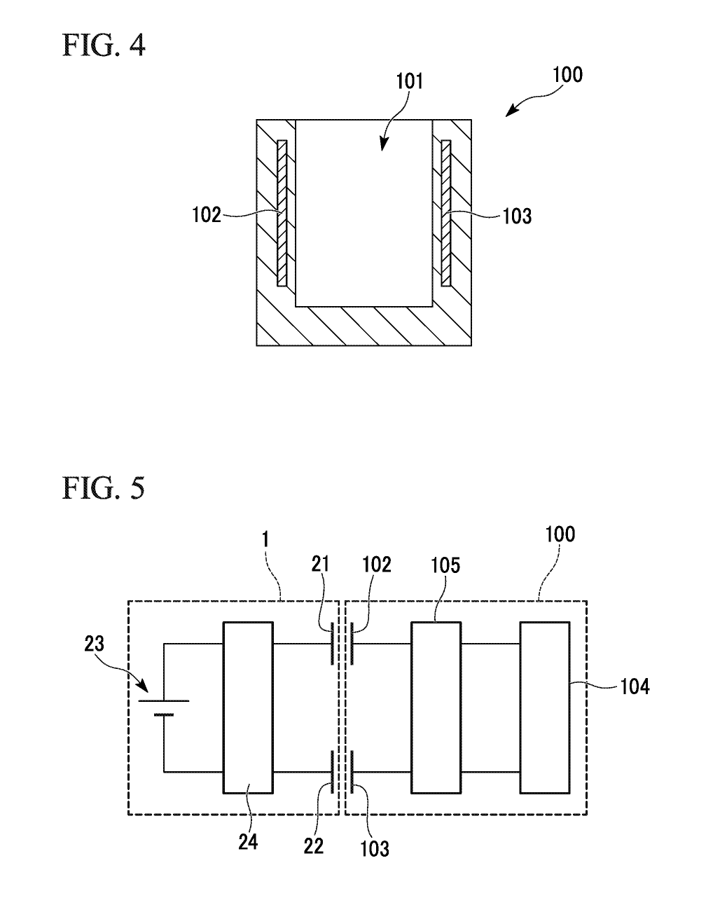

FIG. 4 is a view schematically showing a cross section of the charger 100. The charger 100 is provided with planar first and second power transmission electrodes 102 and 103. The first and second power transmission electrodes 102 and 103 are disposed to run along two surfaces that are facing to each other among an inner surface of the recess 101 and not to be exposed.

When the battery 1 is charged, a user loads the battery 1 in the recess 101 such that the two surfaces on which the first and second power transmission electrodes 102 and 103 are disposed are opposite to the front and rear surfaces 11 and 12 on which the first and second electrodes 21 and 22 are disposed.

FIG. 5 is a circuit diagram showing a state in which, as described above, the battery 1 is loaded in the recess 101. As the first and second power transmission electrodes 102 and 103 face to the first and second electrodes 21 and 22, the facing electrodes are subjected to capacitive coupling (electric field coupling) in a non-contact state, so that a closed circuit including the battery 1 and the charger 100 is formed. The thicknesses of the housing 10 and the heat storage unit 31 are preset such that the aforementioned capacity coupling is made possible. In FIG. 5, a reference numeral 104 indicates a power supply circuit, and a reference numeral 105 indicates a power transmission circuit for adjusting a mode of a current transferred from the charger 100 to the battery 1.

In a state in which the aforementioned circuits are formed, when a high-frequency alternating current is supplied from the charger 100, the alternating current can be transferred to the battery 1 via the capacitively coupled electrodes. The alternating current transferred from the charger 100 is converted into a direct current by the switching unit 24, and thereby the battery cell 23 can be charged.

Since the current supplied from the charger 100 is the alternating current, if the first and second power transmission electrodes 102 and 103 have only to face the first and second electrodes 21 and 22, a correspondence relationship between individual electrodes is not at issue, and charging can be performed even in any correspondence relationship. That is, the first electrode 21 may be disposed to face the first power transmission electrode 102 or face the second power transmission electrode 103.

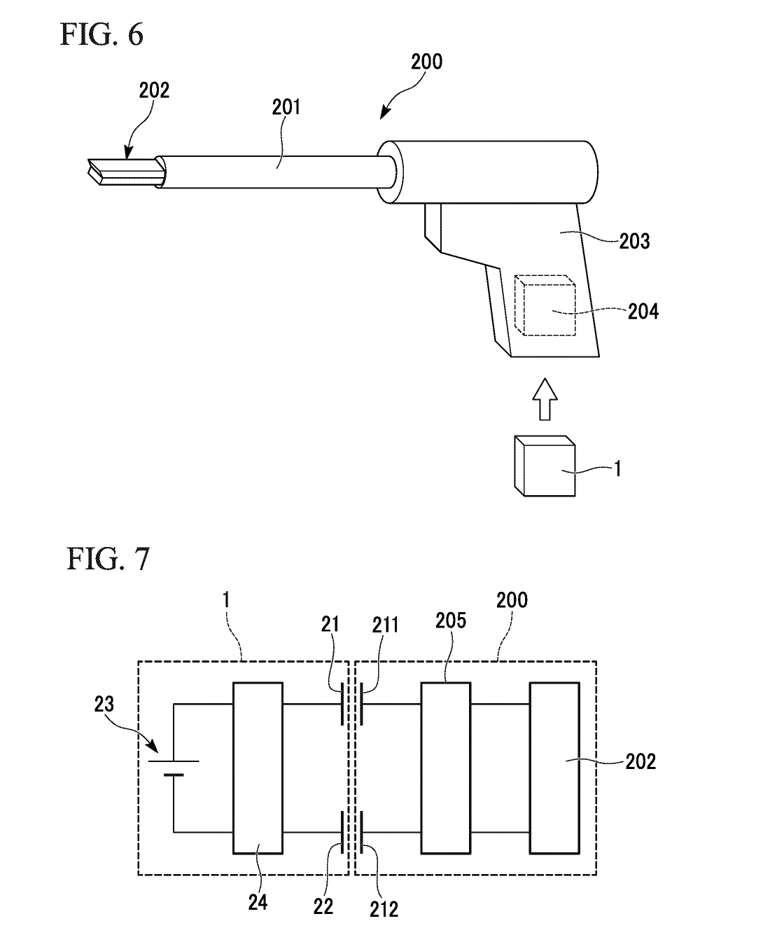

After the battery 1 is charged, the battery 1 can be mounted in the medical instrument, and be used as a power supply. Grasping forceps 200 that is a treatment tool provided with a rigid insertion part 201 and a treatment part 202 provided at a tip of the insertion part 201 is shown in FIG. 6 as an example of the medical instrument. The targeted medical instrument is not limited to the treatment tool, and may be applied without being particularly restricted as long as it is energized and used.

A recess 204 for housing the battery 1 is provided in a handle 203 of the grasping forceps 200. The recess 204 may have the same shape as the recess 101 of the charger 100. The grasping forceps 200 are provided with a pair of power reception electrodes acting as the first and second power reception electrodes. Although not shown in FIG. 6, the first and second power reception electrodes are disposed to run along two surfaces that are facing to each other among an inner surface of the recess 204 and not to be exposed to the outside.

FIG. 7 is a circuit diagram of a circuit formed when the battery 1 is discharged in the grasping forceps 200. As the aforementioned first and second power reception electrodes 211 and 212 face the first and second electrodes 21 and 22, the facing electrodes are capacitively coupled, which is the same as when charging. When the battery 1 is discharged, a direct current removed from the battery cell 23 is converted into an alternating current by the switching unit 24, and the alternating current is transferred to the grasping forceps 200. In the grasping forceps 200, the alternating current supplied from the battery 1 is appropriately adjusted by a power reception circuit 205, and is supplied to the treatment part 202 which is a load.

When the applied medical instrument is a high-frequency treatment tool using a high-frequency current, the supplied alternating current may be used as the alternating current as is by adjusting only a voltage or current value by the power reception circuit 205. When the medical instrument uses the direct current, for example, to turn on a light source, a converter circuit or the like may be configured to be appropriately provided in the power reception circuit 205 and to enable the supplied alternating current to be converted into the direct current.

As described above, the battery 1 of the present embodiment can be electrically connected to any of the charging mechanism such as the charger and the discharging mechanism such as the medical instrument without the terminals formed of a conductor such as a metal. Therefore, the battery 1 enables power reception and power transmission despite the configuration in which the entire outer surface thereof is covered by the dielectric housing 10, and can be suitably used as a battery.

Since the heat storage unit 31 is provided between the inner surface of the housing 10 and the first electrode 21 and between the inner surface of the housing 10 and the second electrode 22, when the battery 1 is exposed to a high-temperature environment, most of the heat applied to the housing 10 is absorbed by the heat storage unit 31. As a result, heat transferred to the first and second electrodes 21 and 22 is transferred via the wiring 25, or is directly radiated from the housing 10, and thereby a rise in the temperature of the battery cell 23 is inhibited.

Further, since the battery 1 does not have parts such as the terminals that are formed of a conductor, are exposed to the outer surface thereof, and are connected to an internal mechanism by a conductor such as wiring, when the battery 1 is exposed to a high-temperature environment, no heat is conducted to the inside of the battery from the terminals or the like.

In addition, in comparison with a case in which thermal conduction to the first and second electrodes 21 and 22 is inhibited only by a heat insulating material, a big effect of inhibiting the thermal conduction can be obtained even if the heat storage unit 31 is formed to be thin, and thus it is also easy to design the battery 1 in the way of enabling capacitive coupling.

Due to the above operation, the heat resistance of the battery 1 is remarkably improved. Therefore, for example, even if the grasping forceps 200 is autoclaved with the battery 1 mounted therein, the battery performance is hardly degraded. The battery 1 can be suitably used as a medical battery.

However, the battery 1 is different from a typical battery, and both input and output into and from the battery 1 are the alternating currents. A frequency of the alternating current is preferably a frequency having a high-frequency band of about 100 kHz to 1 GHz.

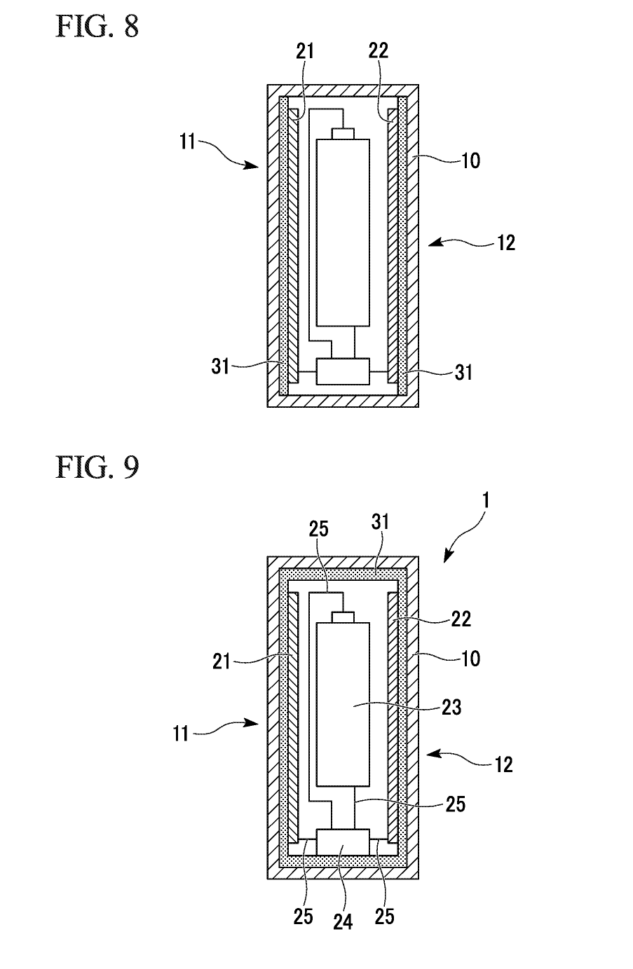

In the present embodiment, the example in which the heat storage unit is disposed to cover the entire inner surface of the housing has been described, but a mode in which the heat storage unit is provided is not limited thereto. For example, as shown in FIG. 8, the heat storage unit 31 may be disposed to cover only the front and rear faces 11 and 12 on which the first and second electrodes 21 and 22 are disposed among the inner surface of the housing 10.

As in a modification shown in FIG. 9, the heat storage unit 31 may be in contact with the switching unit 24 in addition to the first electrode 21 and the second electrode 22. With this configuration, even when the first electrode 21, the second electrode 22, and the switching unit 24 generate heat, the heat storage unit 31 absorbs the heat, and thus the generated heat can be inhibited from being transferred to the battery cell 23 via the wiring 25.

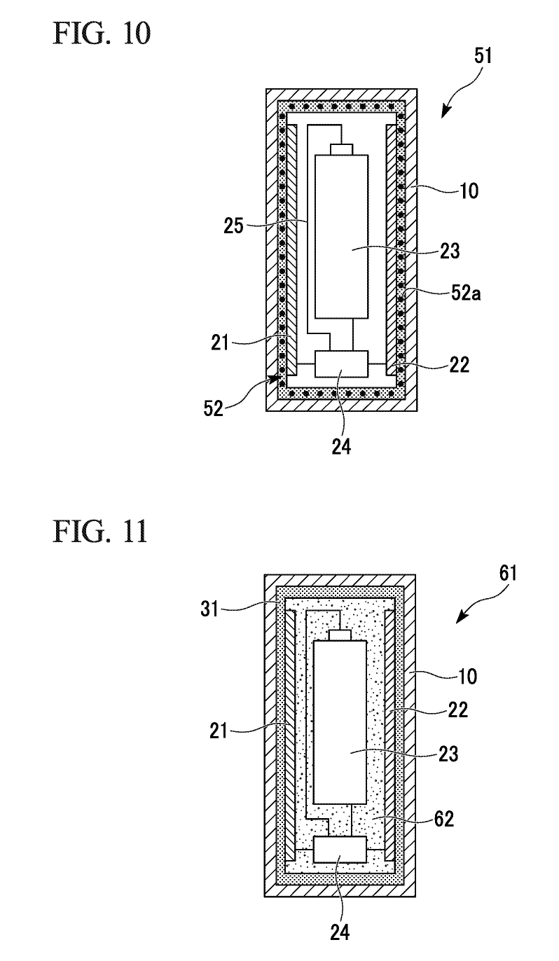

Next, a second embodiment of the present invention will be described with reference to FIG. 10. A difference between a battery 51 of the present embodiment and the aforementioned battery 1 is the configuration of the heat storage unit. In the following description, the same components as previously described are given the same reference numerals, and a duplicate description thereof will be omitted here.

FIG. 10 is a sectional view of the battery 51. A heat storage unit 52 of the present embodiment is formed including a heat insulating material 52a. A type of the heat insulating material is not particularly restricted, and may be appropriately selected from various known heat insulating materials in consideration of, for example, compatibility with a heat storage material used in the heat storage unit 52. A shape of the heat insulating material is also not particularly restricted. A granular heat insulating material is shown in FIG. 10. However, the heat insulating material may be disposed, for example, between the heat storage material and the first electrode 21 and between the heat storage material and the second electrode 22, for example, by mixing the heat insulating material and the heat storage material in one body or by forming the heat insulating material and the heat storage material in a layered form.

According to the battery 51 of the present embodiment, since the heat storage unit 52 is formed including the heat insulating material 52a, a rise in the temperature of the battery cell 23 can be more reliably prevented.

Next, a third embodiment of the present invention will be described with reference to FIG. 11. As shown in FIG. 11 in a cross section, in a battery 61 of the present embodiment, a heat insulating material is filled inside a housing 10. That is, aside from a heat storage unit 31, a heat insulator 62 is provided around a battery cell 23.

According to the battery 61 of the present embodiment, even when heat above a heat storage amount of the heat storage unit 31 is applied to the housing 10, the heat is inhibited from being transferred to the battery cell 23, and thus the battery 61 can be formed in a structure having higher heat resistance. Since the heat insulator 62 supports the battery cell 23 or a switching unit 24, unintended thermal conduction or the like caused by a change in position or posture of the battery cell 23 or the switching unit 24 can also be inhibited in the housing 10.

The heat insulator 62 of the present embodiment may be formed of a heat storage material. The heat insulator 62 is formed of the heat storage material, and thereby an effect of inhibiting a rise in the temperature of the battery cell can be further enhanced.

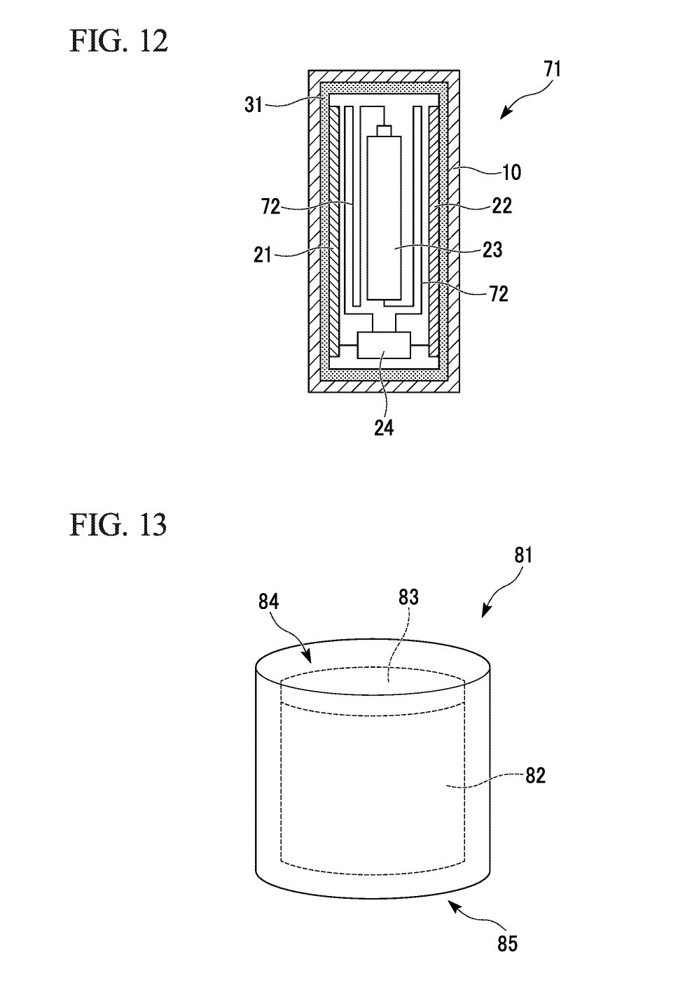

Next, a fourth embodiment of the present invention will be described with reference to FIG. 12. As shown in the cross sectional view of FIG. 12, in a battery 71 of the present embodiment, wiring 72 connecting a battery cell 23 to a first electrode 21 and a second electrode 22 is disposed to meander, and thereby is set to be equal to or more than a given length.

When thermal conduction caused by the wiring is inhibited, a method of reducing a diameter of the wiring is generally taken. However, in the case of using the battery of the present invention, when application of the battery to a device having a large amount of current such as a high-frequency treatment tool is considered, a limit to the method of reducing a diameter of the wiring depending on an amount of used current in order to avoid generation of heat of the wiring itself due to electrical resistance occurs in some cases.

According to the battery 71 of the present embodiment, since a length of the wiring 72 is set to be equal to or more than a given length, it is possible to increase the time until heat transferred to the first and second electrodes 21 and 22 is transferred to the battery cell 23 via the wiring 72. As a result, the influence of the heat on the battery cell 23 can be inhibited by keeping the diameter of the wiring 72 constant, without raising electrical resistance per unit length.

In the present embodiment, a given length of the wiring 72 can be appropriately set. However, for example, when the battery cell is 4 cm in a longitudinal direction thereof, the length of the wiring 72 is preferably equal to or more than 8 cm. The given length also depends on a size of the battery cell, but it is sometimes sufficient to be a length going back and forth in the longitudinal direction of the battery cell or a length going around a footprint. A dielectric coating is preferably applied to the wiring 72 to prevent a short circuit caused by meandering.

While embodiments of the present invention have been described, the technical scope of the present invention is not limited to the aforementioned embodiments. Without departing from the scope of the present invention, a combination of the components may be changed, or each component may be modified in various ways or be eliminated.

For example, in each of the above embodiments, the example in which the first electrode and the second electrode are formed in a planar shape and are connected to the charger or the like by capacitive coupling is given. Alternatively, the first electrode and the second electrode may be formed in the shape of one coil as a whole, and be electrically connected to the charger or the like in a non-contact state by coupling using a magnetic field in an electromagnetic induction or magnetic resonance type. In this case, since generation of heat of the coil-shaped electrode during power reception and transmission is considered, the heat storage unit is preferably provided between the coil-shaped electrode and the battery cell to be in contact with both the coil-shaped electrode and the battery.

In each of the above embodiments, switching between the charging and the discharging by the switching unit may be automatically performed, for example, by identifying a device to which the battery is connected, or having a configuration in which a user designates a switching mode. In the latter case, a switch for the switching may be provided on an outer surface of the battery while sealing of the inside of the housing is maintained.

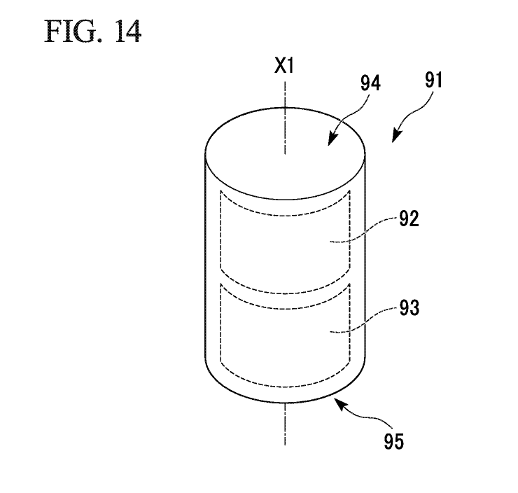

An external shape of the battery is not limited to the cuboidal shape shown in each of the above embodiments. Therefore, the external shape of the battery may be shapes other than the cuboidal shape such as a columnar shape whose bottom is oval like a battery 81 of a modification shown in FIG. 13 or a cylindrical shape like a battery 91 of a modification shown in FIG. 14.

Further, depending on the external shape, the arrangement of the first electrode and the second electrode can also appropriately set. In the battery 81, a first electrode 82 and a second electrode 83 are arranged on opposite sides in the direction of a minor axis in an oval cross section. According to this arrangement, even if the battery is loaded in the recess provided in the charger or the medical instrument in any geometric direction, the battery can perform power reception and transmission. That is, it does not matter that the battery is inserted into the recess from any of a top surface 84 and a bottom surface 85.

In view of a circuit configuration, since the battery of the present invention outputs the alternating current, the battery has no polarity. Therefore, there is also no need to pay attention to directions of the first and second electrodes 82 and 83.

In the battery 91, a first electrode 92 and a second electrode 93 are arranged to be aligned in a direction of an axis X1 of a cylindrical shape and to have the same phase in a circumferential direction. In the case of this arrangement, the battery 91 is identical to the battery 81 in that it does not matter that the battery 91 is inserted into a recess from any of a top surface 94 and a bottom surface 95. However, according to the way of loading, there is a possibility in which electrodes provided in a charger or the like are not opposite to the first and second electrodes 92 and 93. To prevent this, for example, a key is provided for one of the battery and the charger, and a key groove for engaging with the key is provided in the other. Thereby, when the battery is loaded in the charger or the like, the battery may be necessarily made in a given form. As another method, even if the electrodes provided in at least one of the battery and the charger are arranged to extend over the entirety in a circumferential direction, the electrodes provided in the charger or the like and the electrodes of the battery can be made reliably opposite to each other at the time of loading.

Although embodiments of the present invention have been described, the technical scope of the present invention is not limited to these embodiments. The combinations of the components in the embodiments can be changed without departing from the gist of the present invention, or each component can be variously modified or removed. The present invention is not limited by the above description.

What is claimed is:

1. A medical battery comprising:
a chargeable and dischargeable battery cell;
a first electrode and a second electrode connected to the battery cell and electrically connected to external electrodes in a non-contact state;
a switching unit provided in a battery circuit including the battery cell, the first electrode, and the second electrode, the switching unit being configured to switch a current flowing through the battery circuit to an alternating current or a direct current;
a dielectric housing configured to seal and house the battery cell, the first electrode, the second electrode, and the switching unit therein; and
a heat storage unit arranged between an inner surface of the housing and the first electrode, and between the inner surface of the housing and the second electrode.

2. The medical battery according to claim 1, wherein the heat storage unit is arranged to cover the entire inner surface of the housing.

3. The medical battery according to claim 1, wherein the heat storage unit is in contact with the first electrode, the second electrode, and the switching unit.

4. The medical battery according to claim 1, wherein the heat storage unit is formed by including a heat insulating material.

5. The medical battery according to claim 1, wherein each of the first electrode and the second electrode is formed in a planar shape, and is electrically connected to the external electrodes by capacitive coupling.

6. The medical battery according to claim 1, wherein the housing is formed of a material, a dielectric constant of which is equal to or more than 2.

7. The medical battery according to claim 1, further comprising a heat insulator arranged around the battery cell.

8. The medical battery according to claim 1, wherein the switching unit is configured to switch between a charging mode and a discharging mode.

9. The medical battery according to claim 1, wherein wiring connected between the first electrode and the battery cell, and between the second electrode and the battery cell is equal to or more than a predetermined length.
